(19) United States
(12) Patent Application Publication
(10) Pub. No.: US 2009/0204492 A1
(43) Pub. Date: Aug. 13, 2009

(54) Online food ordering system and method

(76) Inventors: Danilo Scifo, Coral Springs, FL (US); Marianne Scifo, Coral Springs, FL (US); Daniel Scifo, Coral Springs, FL (US); Lisa Valente, Coral Springs, FL (US); Robert Valente, Coral Springs, FL (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/069,895

(22) Filed: Feb. 13, 2008

(51) Int. Cl. G06Q 30/00

(52) U.S. Cl. 705/14; 705/1

(57) ABSTRACT

Restaurants register for an online food ordering system and method to have their menus presented on the online system. Registration is accomplished by payment of a fixed registration fee. A merchant account is created for each restaurant. The merchant account is associated with a unique account key that includes a local delivery indicator and direct payment receivable account information facilitating direct payment to the restaurant's account. A first server is appointed for receiving orders from customers. The first server includes a data storage device having menu items and information from each of the restaurants and each of the unique account keys associated with each restaurant. In communication with the first server are second and third servers for processing payments and transmitting orders to the restaurant for processing and fulfillment. An order confirmation means is further provided for notifying the customer upon submission of the order to the restaurant along with estimated pick-up or delivery times.

### BACKGROUND OF THE INVENTION

1. Field of the Invention

The present invention relates to a method and system for an online food ordering infrastructure; and more particularly to an online food ordering system and method wherein a server includes a data storage device with menu information concerning each participating restaurant stored therein and, as consideration for a fixed registration fee, each restaurant receives a merchant account associated with a unique account key for direct payment thereto.

2. Description of the Prior Art

Online food ordering is becoming increasingly utilized. Assorted online food ordering systems and methods are currently provided for achieving an array of objectives.

Various online systems and methods have been employed for accounting, tracking ingredients, maintaining or ordering supplies, and delivery or mobile pickup station services. Examples of each of these various type of systems and methods are as disclosed by U.S. Patent Application Publication No. 2004/0107141 to Conkel et al.; U.S. Patent Application Publication No. 2005/0055283 to Zarovinsky; U.S. Patent Application Publication No. 2006/0293965 to Burton; Foreign Publication No. KR 20040016500 to Bae et al.; Foreign Publication No. WO 200198992 to Fante et al.; and U.S. Patent Application Publication No. 2007/0150375 to Yang. These systems and methods have greater application in large orders, as it involves food ingredient providers as well as restaurants themselves, rather than family or individual orders.

While other systems and methods provide interactive order processing systems that directly navigates potential customers directly to a given restaurant's own website, such as disclosed by U.S. Patent Application Publication No. 2002/0019779 to Healey et al., and does not provide a remote food ordering system having a plurality of restaurants to choose from for pick-up and/or delivery. Further systems provide in-restaurant electronic order system for utilization by customers at the restaurant during the dining experience, which interfaces directly with the kitchen or the like, such as disclosed by U.S. Patent Application Publication Nos. 2004/0158494 to Suthar and 2005/0273345 to Castillejo Romero, and see article written by Stanford, V., “Pervasive computing puts food on the table”, IEEE, Vol. 2, Iss. 1, January-March 2003, p 9-14.

Moreover, varied systems and methods have been constructed for coordinating and scheduling group interactions or dining experiences based at least in part on the group affiliations such as that disclosed by U.S. Patent Application Publication Nos. 2006/0053061 to Evans and 2007/0150321 to Zhao et al. These systems and methods are structured and operate as platforms for online group feasts and do not provide an online, remote ordering system, for utilization by individual consumers or families that is appointed to provide consumers with a plurality of restaurant menus for ordering food for pick-up or delivery.

Where systems and methods have been provided for online food ordering services for consumers and families, many of these systems are structured in a manner that involves payment of a percentage of the order to the online service provider, resulting in extraneous fees added to the bill. Additionally, /or further fees may be encumbered for faxing orders, etc. Examples include: U.S. Pat. No. 5,991,739 to Cupps et al.; U.S. Patent Application Publication Nos. 2005/0108097 to McAleenan and 2006/0080176 to Sutcliffe; and “Hungry? EatNow.com”, found at http://www.eatnow.com. These systems and methods do not disclose forming a restaurant account via a fixed registration fee and instead are structured and operate to charge commissions and fees based on orders received through the systems. Such extraneous charges tend to cause the cost to become greatly exaggerated, and thus yield a venue which consumers utilize on limited occasions as it becomes more cost effective to forego the online ordering system and directly order from the given restaurant.

Even where various systems and methods have been disclosed that do not provide payment of extraneous fees and commissions and the like, these systems and methods do not provide an online food ordering system wherein restaurant merchants are registered with the system by paying a fixed registration fee and receive a unique merchant account for receiving payments directly to the restaurant, while further providing the ability for the restaurants to interact directly with customers for order confirmation and the like. Such online order systems and methods are disclosed by U.S. Patent Application Publication Nos. 2003/0014323 to Scheer, 2003/0126016 to Asano, 2004/0044578 to Kim et al., and Internet sites found at http://www.waiter.com, http://www.delivery.com and http://www.seamlessweb.com. Many of these disclosed online food ordering systems do not provide order confirmation wherein the restaurant has the ability to contact the customer directly. Significantly, the online food ordering systems and methods are not structured having a merchant account associated with a unique account key is created for each restaurants that includes a local delivery indicator and a direct payment receivable account for each restaurant after the merchant pays a fixed registration/member fee.

Notwithstanding the efforts of prior art workers, there remains a need in the art for an improved online food ordering system and method having a merchant account created for each restaurant that is associated with a unique account key which includes a local delivery indicator and direct payment means for each restaurant. In addition, there exists an art recognized need for an online food ordering system and method structured with a fixed fee to be paid by each restaurant for registration onto the system, so that no commission based fees or extraneous fees are charged to the customer's bill or the restaurant.

### SUMMARY OF THE INVENTION

The present invention provides an online food ordering system and method that creates a merchant account for each restaurant that is registered with the system. Registration onto the online system is achieved by the restaurant paying a fixed registration fee with the online service provider. In this manner, there are no other extraneous fees or commissions to be paid by the restaurant based on orders received or other financial structures. A unique account key is assigned with each merchant account for each restaurant which includes a local delivery indicator and direct payment means for each restaurant.

The online food ordering system comprises a merchant account created for each restaurant of a plurality of restaurants. The merchant account is associated with a unique account key for each of the restaurants. This unique account key includes a local delivery indicator and is associated with a direct payment receivable account for each of the restaurants. A fixed fee is provided that must be paid by each of the restaurants to register the restaurant in creating the merchant account and listing the restaurant's menu and other information on the systems internet site. A first server is provided that includes a data storage device having menu items and information from each of the restaurants and each of the unique account keys associated with each restaurant is stored thereon. The first server is appointed for receiving a plurality of orders from a plurality of customers. A second server is provided that is in communication with the first server and includes a credit card authorization memory device and means for processing a credit card payment from the customer and transmitting the entire payment directly to the payment receivable account of the merchant. The system further includes a third server that is in communication with the first and second servers which receives the order from the first server, and transmits the order to the restaurant for processing and fulfillment. Order confirmation means is further provided for notifying the customer that the order is submitted to the restaurant and will be fulfilled.

An online food ordering method is provided. The method comprises the steps of: (i) creating a merchant account for each restaurant of a plurality of restaurants, the merchant account being associated with a unique account key for each of the restaurants, the unique account key including a local delivery indicator and being associated with a direct payment receivable account for each of the restaurants; (ii) submitting a fixed fee to be paid by each of the restaurants to register the restaurant in creating the merchant account; (iii) creating a first server including a data storage device having menu items and information from each of the plurality of restaurants and each of the unique account keys stored thereon, the first server appointed for receiving a plurality of orders from a plurality of customers; (iv) networking a second server in communication with the first server and including a credit card authorization memory device and means for processing a credit card payment from the customer and transmitting entire the payment directly to the payment receivable account of the merchant; (v) networking a third server in communication with the first and second servers which receives the order from the first server, and transmits the order to the restaurant; and (v) proving order confirmation means.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 illustrates configuration of the online ordering system according to the present invention;

FIG. 2 illustrates a flow chart showing the establishment of a merchant account; and

FIG. 3 illustrates a flow chart illustrating a process for ordering food on the online ordering system and method.

### DETAILED DESCRIPTION OF THE INVENTION

The present invention provides an online food ordering system and method that creates a merchant account for each restaurant that is registered with the system. Registration onto the online system is achieved by the restaurant paying a fixed registration fee with the online service provider. In this manner, there are no other extraneous fees or commissions to be paid by the restaurant based on orders received or other financial structures. A unique account key is assigned with each merchant account for each restaurant which includes a local delivery indicator and direct payment means for each restaurant.

The improved online food ordering system and method simply charges one flat fee for registration of every restaurant and does not take a percentage of the order and charge additional charges for faxing, like many other online food ordering service companies. The online food ordering system and method uniquely provides an online food ordering service hosting all local restaurant menus structured through creating merchant accounts for each individual restaurant. Unlike currently utilized online food ordering services, which operate by taking a percentage of the order and charge additional charges for faxing, etc., the online food ordering system and method provides a fixed fee structure paid by the merchant/restaurant. Ultimately, any commission fees accumulated due to the use of the commission fee based structures will be spread-out and absorbed into the restaurant's prices and thus paid by the consumer. The online food ordering system and method herein does not receive any money for the orders that are placed and money instead is transferred directly into each individual restaurant's account. As a result, merchants/restaurants have more control over the price of their food dishes/items listed on the on-line menu and will not be encumbered by inflated prices due to commissions and the like that must be paid out with each order. Thus the improved online food ordering system and method creates a cost-attractive online food ordering service wherein prices for the food goods can be dramatically less than that provided by other food ordering services, providing practical pricing structures that yield a regular meal venue for consumers and families.

The online food ordering system and method provides an online food ordering service that hosts all local restaurant menus, divided and arranged according to zip code (with a mile radius inserted therein which provides the distance the customer is willing to travel or the delivery distance radius set by the restaurant where delivery is concerned). The online food ordering system and method establishes merchant accounts for each restaurant to enable the restaurant to receive direct payments to their account. The online food ordering system allows a restaurant to receive orders via fax and/or e-mail to provide fully interactive online menu and order confirmation capabilities. One flat fee is charged for the service to the restaurant merchant. There are no percentages or commissions or other extraneous fees or charges incurred to the restaurants or customers utilizing the site for ordering food.

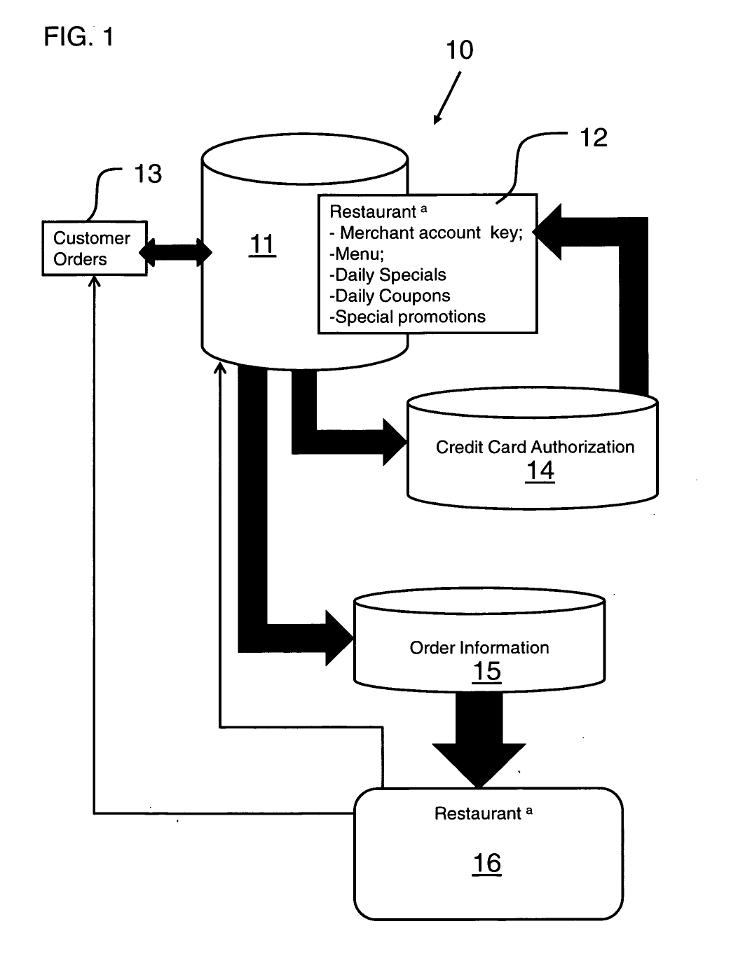

FIG. 1 illustrates configuration of the online ordering system according to the present invention, shown generally at 10. A merchant account is created for each restaurant registered with the system. The merchant account is associated with a unique account key for each of the restaurants. The unique account key includes a local delivery indicator and is associated with a direct payment receivable account for each of the restaurants. For example, for a given geographical location having a zip code 22222 the local delivery indicator may include -222 and the unique account key for the given restaurant located in the delivery zone may include numbers xxxxxx-222 so that the system can readily ascertain the delivery zone/pickup zone of the restaurant. A first server 11 including a menu memory device having data 12 stored therein is provided. This data 12 includes data relating to each registered restaurant, herein showing restaurant^{a}, which provides data accessible for viewing by customers as they enter the online site, such as the menu, daily specials and coupons, and special promotions issued by the restaurant. Confidential stored data includes the restaurant's associated merchant account key. Each restaurant merchant has access to change or update daily specials, coupons, promotions, and menu information as needed.

First server 11 is appointed for receiving a plurality of orders from a plurality of customers 13 via an Internet site. A fixed fee is paid by each of the restaurants to register the restaurant in creating the merchant account. A second server 14 including a credit card authorization memory device and means for processing a credit card payment from customer 13 and transmitting the entire payment directly to a payment receivable account of the merchant/restaurant 12 is provided via associated merchant account. In this manner the restaurant 12 receives the entire payment from the customer's 13, without needing to wait for the payment at a later time. A third server 15 receives the order from first server 11, and upon notification of payment, transmits the order to restaurant 16 for confirmation and delivery or pick-up information. Order confirmation means are generated from the restaurant to either first server 11, which in turn e-mails or faxes same to customer 13, or directly to customer 13 via phone, facsimile, and/or email. Customer 13 may have the option to designate confirmation means, selecting by phone, e-mail, facsimile or text message and may select direct confirmation from the restaurant.

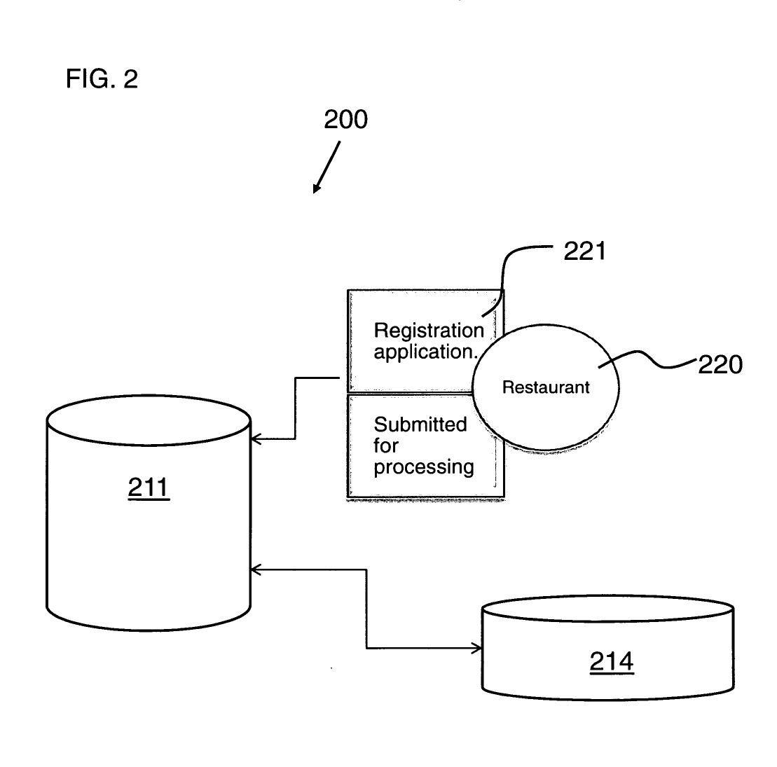

FIG. 2 illustrates a flow chart showing the establishment of a merchant account, shown generally at 200. A merchant account is set-up by the associated URL, i.e. to be associated under the trademark and domain name Menusonhand.com™, for each merchant/restaurant with an electronic payment systems, such as associated with those offered under the trademarks Total Merchant Processing Solutions Inc./USA E-Pay. In this manner, restaurants get paid everyday as the orders come in, rather than every two weeks or once a month like other companies' services. The steps involved with establishing the merchant account for each of the restaurants include: (1) restaurant owner 220 submit a 3-step application 221 online, where it is sent directly to the first server 211; (2) all the business information of application 221 is sent to a second server 214 operated by an electronic payment system, such as associated with those offered under the trademarks Total Merchant Processing Solutions Inc./USA E-Pay; (3) second server 214 will provide first server 211 with an instant approval and an account key for restaurant owner 220; (4) an electronic payment account key is then entered into first server' 211 memory storage device associated with restaurant owner 220; and (5) thus a gateway is created for each restaurant owner/restaurant 220 to receive payment for every order as it is processed.

First server 211 includes a menu memory device having menu items from each of the plurality of restaurants 220 (220a-220n) and each restaurant's 220 unique account key is stored thereon. Each restaurant 220 (220a-220n) may be provided with an access code in order to make modifications to their menu, such as food modifications or/and price modifications, as well as provide a page for daily food specials or coupon offerings or promotions. Alternatively, the restaurant calls in the changes to their menu and these changes are made on the first server. The second server 214 includes a credit card authorization memory device and means for processing payments for food orders.

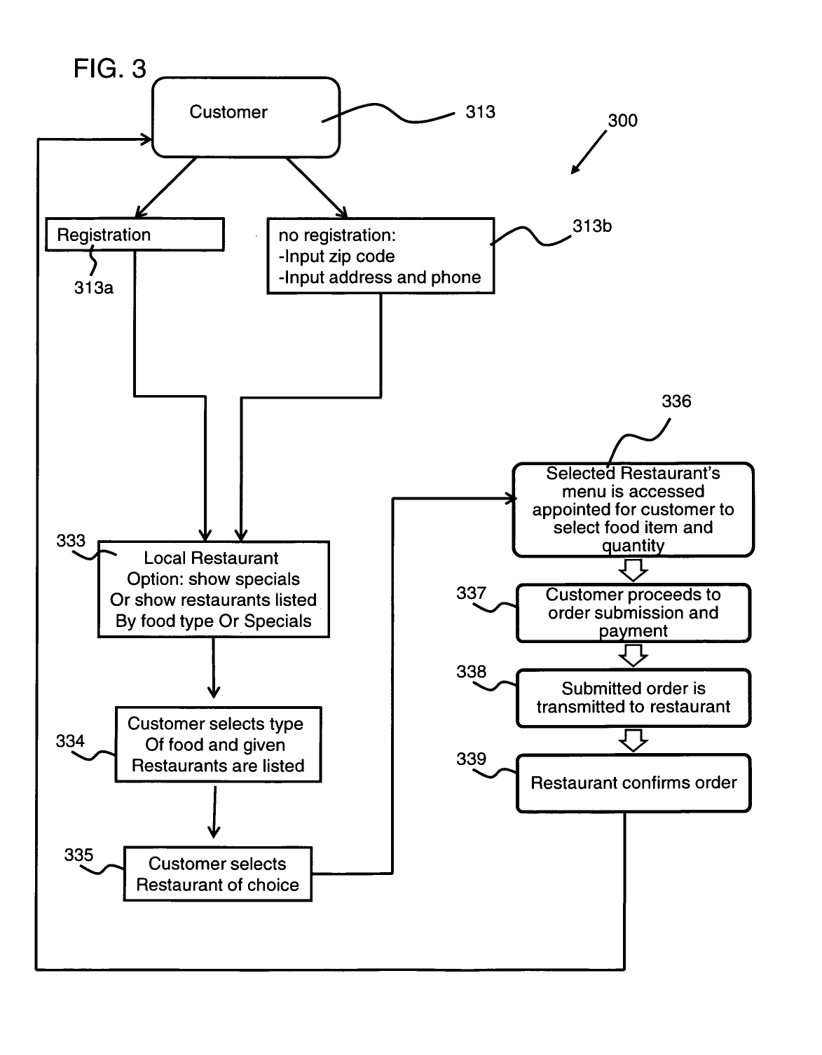

FIG. 3 illustrates a flow chart illustrating a process for ordering food on the online ordering system and method, shown generally at 300. After the merchant account is set-up as per FIG. 2 and menu information and account key assignments are stored in the memory device of the first server, an order may be placed by a customer 313. The order is transmitted to the second server for credit card authorization. Upon authorization, the order is then sent via email to the particular restaurant. A fax queue is transmitted from first server to a third server (i.e. such as offered under the trademark Premier Global), which in turn faxes the order to the restaurant. After the third server faxes the order to the restaurant, a confirmation is sent to the first server and an email is generated confirming that the restaurant has received the order and it is being prepared. The restaurant may contact the customer 313 via telephone or email to confirm order and give estimated delivery or pick-up time. In operation, customer 313 logs onto the Internet site associated with the online food ordering system. Customer 313 may register with the system and enter as a registered customer 313a, or may opt not to register with the system and enter the system as an unregistered customer 313b. It does not cost customer 313 any money to become a registered customer 313a, but rather merely provides that customer 313 will not have to input their information each time he/she utilize the service. Registered information includes the customer's address, telephone, e-mail address, facsimile number, and may include stored credit card payment information or food preferences/restaurant preferences. Other information may be included on the registered customer information such as food allergies of the customer or family members, so that if the customer selects a dish or entry containing the food (such as peanuts) the customer will immediately receive an alert that the food item includes the allergy inducing substance (i.e. such as peanuts). As food allergies are becoming more prevalent, especially in regards to peanuts, and same can be very dangerous to individuals suffering from the allergy, this feature is advantageous in catering to individual's needs and safety. IN such a manner, when restaurants register with the system, the restaurant would be prompted to indicate if peanuts are utilized in preparation of any of the menu items, and if so, are prompted to designate such items. If customer 313 elects, he/she does not have to register with the site and can instead opt to be an unregistered customer 313b and hence enter their contact and pertinent information for delivery/or order of food. In an alternative embodiment, it is a necessary requirement for customer 313 to be registered in order to be eligible to place a food order.

Based upon the zip code or other geographical factor, customer 313 is preferably prompted to via local restaurant option 333, which allows customer 313 to select whether he/she would prefer: (i) a list of all the local restaurants in the delivery locality (i.e. based on the restaurants inputted information as to how far the restaurant is willing to drive to deliver, such as a 20 mile radius), pick-up locality (i.e. customer inserts miles willing to travel to pick-up food, selections ranging from a 5 to 45 mile radius); (ii) categorized offerings of types of foods: such as Chinese, Japanese, Sushi, Mediterranean, Pizza, Deli, Italian, etc., upon which customer 313 may select the category or type of food and the local restaurants only offering the select type of food will be listed. As such, the customer can bore readily select their desired restaurant based on the type of food they are interested in eating; or (iii) categorized via special offerings or promotions for the day/week.

After customer 313 selects type of food and given restaurants are listed/locality at 334, customer 313 selects the restaurant of choice at 335 and the selected restaurant's menu is shown 336. Customer 313 then selects the food items and quantity. Customer 313 also is provide with a special request box for inserting special preparation requests, comments, or questions to be answered by the restaurant or service. Upon which time customer 313 proceeds to checkout and order submission 337. The submitted order is then transmitted to the restaurant via facsimile, or email, or text message once payment is processed 338 and the restaurant confirms the order 339. Confirmation may be achieved by the restaurant notifying the server (first server) or notifying the customer directly. Wherein the server is notified, the server can then notify the customer directly minutes after payment on the site, or can email the customer, text message the customer, or a call service can be provided that calls the customer. The restaurant may notify the customer directly via phone call, fax, e-mail, or through text messaging. The confirmation preferably includes estimated time of delivery (or estimated time for order pick-up).

Promotions may be provided on the site, including cash rewards to be utilized when a customer spends a given amount of money ordering from restaurants through the site. Such as, for every $125 dollars spent by a registered customer, the customer receives a cash reward of $10 dollars to be utilized for ordering from participating registered restaurants. Other promotions may include, for example, the case where a customer orders a given dollar amount from the site; in that case, the customer receives a fee appetizer or entree from participating registered restaurants. A rating system may further be provided on the site, rating the timeliness of order processing, and/or food quality, etc.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An online food ordering system, comprising:
a. a merchant account created for a plurality of restaurants, said merchant account being associated with a unique account key for each of said restaurants, said unique account key including a local delivery indicator and being associated with a direct payment receivable account for each of said restaurants;
b. a fixed fee to be paid by each of said restaurants to register said restaurant in creating said merchant account;
c. a first server including a data storage device having menu items and information from each of said plurality of restaurants and each of said unique account keys stored thereon, said first server appointed for receiving a plurality of orders from a plurality of customers;
d. a second server in communication with said first server and including a credit card authorization memory device and means for processing a credit card payment from said customer and transmitting substantially the entire amount of said payment directly to said payment receivable account of said merchant;
e. a third server in communication with said first and second servers which receives said order from said first server, and transmits said order to said restaurant; and
f. order confirmation means.

2. An online food ordering system as recited by claim 1, wherein in addition to said fixed fee paid for registering each of said restaurant, said restaurant pays an annual or biannual fee.

3. An online food ordering system as recited by claim 1, wherein each of said merchant is allowed means to present coupons or various offers to consumers on said system.

4. An online food ordering system as recited by claim 1, wherein said system includes a daily specials section having a daily special page for each of said restaurant.

5. An online food ordering system as recited by claim 4, wherein each of said restaurants are allowed means to access and change said daily special page for food specials and/or daily coupons or promotional messages.

6. An online food ordering system as recited by claim 1, wherein said order confirmation means includes said restaurant contacting said customer directly via a method selected by said customer, including a telephone call, an email communication, a facsimile communication, or a text message communication to confirm an order and to give an estimated delivery or pick-up time.

7. An online food ordering system as recited by claim 1, wherein said order confirmation means includes said restaurant contacting said first server and said first server contacting said customer via a method selected by said customer, including a telephone call, an email communication, a facsimile communication, or a text message communication to confirm an order and to give an estimated delivery or pick-up time.

8. An online food ordering system as recited by claim 1, wherein said customer registers with said system so that contact information for said customer can be stored in said data storage device of said first server.

9. An online food ordering system as recited by claim 8, wherein said information further comprises payment information of said customer.

10. An online food ordering system as recited by claim 8, wherein said information further comprises restaurant preference information of said customer.

11. An online food ordering system as recited by claim 8, wherein said information further comprises information regarding any food allergy of said customer or family members of said customer, wherein an alert is submitted to said customer when said customer selects a food item or entre which ingredient includes said food allergy inducing substance.

12. An online food ordering system as recited by claim 1, wherein said customer is prompted to select all registered local restaurants.

13. An online food ordering system as recited by claim 1, wherein said customer is prompted to select local restaurants categorized based on type of food offered or specialty.

14. An online food ordering system as recited by claim 1, wherein said customer is prompted to select local restaurants categorized via special offerings or promotions for the day/week deals.

15. An online food ordering method, comprising the steps of:
a. creating a merchant account for each restaurant of a plurality of restaurants, said merchant account being associated with a unique account key for each of said restaurants, said unique account key including a local delivery indicator and being associated with a direct payment receivable account for each of said restaurants;
b. submitting a fixed fee to be paid by each of said restaurants to register said restaurant in creating said merchant account;
c. creating a first server including a data storage device having menu items and information from each of said plurality of restaurants and each of said unique account keys stored thereon, said first server appointed for receiving a plurality of orders from a plurality of customers;
d. networking a second server in communication with said first server and including a credit card authorization memory device and means for processing a credit card payment from said customer and transmitting entire said payment directly to said payment receivable account of said merchant;
e. networking a third server in communication with said first and second servers which receives said order from said first server, and transmits said order to said restaurant; and
f. proving order confirmation means.

16. An online food ordering method as recited by claim 15, wherein said order confirmation means includes said restaurant contacting said customer directly via a method selected by said customer, including a telephone call, an email communication, a facsimile communication, or a text message communication to confirm an order and to give an estimated delivery or pick-up time.

17. An online food ordering method as recited by claim 15, wherein said order confirmation means includes said restaurant contacting said first server and said first server contacting said customer via a method selected by said customer, including a telephone call, an email communication, a facsimile communication, or a text message communication to confirm an order and to give an estimated delivery or pick-up time.
